(19) United States
(12) Patent Application Publication
(10) Pub. No.: US 2013/0193678 A1
(43) Pub. Date: Aug. 1, 2013

(54) MEDIA PROCESS FOR ADVERTISING

(71) Applicant: THE KENNEDY GROUP INCORPORATED, Willoughby, OH (US)

(72) Inventor: Michael R. Kennedy, Gates Mills, OH (US)

(73) Assignee: THE KENNEDY GROUP INCORPORATED, Willoughby, OH (US)

(21) Appl. No.: 13/756,106

(22) Filed: Jan. 31, 2013

Related U.S. Application Data
(60) Provisional application No. 61/592,702, filed on Jan. 31, 2012.

(51) Int. Cl. B42D 15/00

(52) U.S. Cl. CPC B42D 15/00
USPC 283/67; 281/15.1

(57) ABSTRACT

A media process for advertising includes positioning an insert on a front page of a periodical. The insert is removable from the periodical so that a purchaser can read any periodical content that is positioned under the insert and the insert includes instructions for the user to obtain additional advertising material. A media process for advertising also includes positioning an article onto a front page of a periodical, with the article including advertising material, such as a periodic offer. An apparatus for advertising on a front page of a periodical includes a sleeve for holding an insert, an adhesive applied to a bottom surface of the sleeve, and an insert positioned inside the sleeve.

### FIELD

This disclosure relates to a media process for advertising. In particular, this disclosure concerns utilizing the front page of a newspaper for advertising purposes and an associated apparatus.

### BACKGROUND

Front page advertisements on newspapers have been known in the form of banner ads at the bottom of the front page. Some newspapers will also sell advertising blocks on the top half of a front page of a newspaper, such as in the corners of the front page. Stickers have been plastered on the newspaper's masthead. Post-it notes have also been used on the front page of a newspaper for advertising and couponing purposes. The front page of a newspaper is a highly desirable place to advertise because it is typically the first place a consumer will look after opening the paper. Newspapers often limit the size of any advertisements to maintain a “tasteful” and traditional front page.

### SUMMARY

A media process for advertising and a method of advertising are claimed and disclosed herein. In addition, an apparatus for advertising on a front page of a periodical is claimed and disclosed herein.

### BRIEF DESCRIPTION OF THE DRAWINGS

FIG. 1 is a plan view of a front page of a newspaper incorporating the example front page insert;

FIG. 2 is a plan view of an example insert for use on a front page of a newspaper;

FIG. 3 is a plan view of another example insert for use on a front page of a newspaper;

FIG. 4 is a plan view of another example insert for use on a front page of a newspaper;

FIG. 5 is a plan view of another example insert for use on a front page of a newspaper;

FIG. 6 is a plan view of another example insert for use on a front page of a newspaper;

FIG. 7 is a plan view of another example insert for use on a front page of a newspaper; and

FIG. 8 is a flowchart showing one example method of advertising using an insert that is positioned on advertising media.

### DETAILED DESCRIPTION

The example media process for advertising involves the use of advertising media 10 on a front page of a newspaper 12 that provides a means for advertising that can be positioned anywhere on a front page of a newspaper and that is removable without substantially marring the newspaper. It is desirable to provide an insert 14 on the front page so that greater advertising content can be provided to a reader. The insert may have a size that is equal to, less than, or greater than the size of a sleeve into which the insert is positioned. A full-size insert is one that is typically the approximate same size as a sheet of paper, such as 8½×11 inches, or similar dimensions. Readers will often ignore the inserts inside a newspaper, but may be intrigued by an advertising circular that is positioned on the front page of a newspaper or other periodical. In addition to positioning an insert on the front page, the example described herein also involves positioning a sample product or other materials on the front page of a periodical.

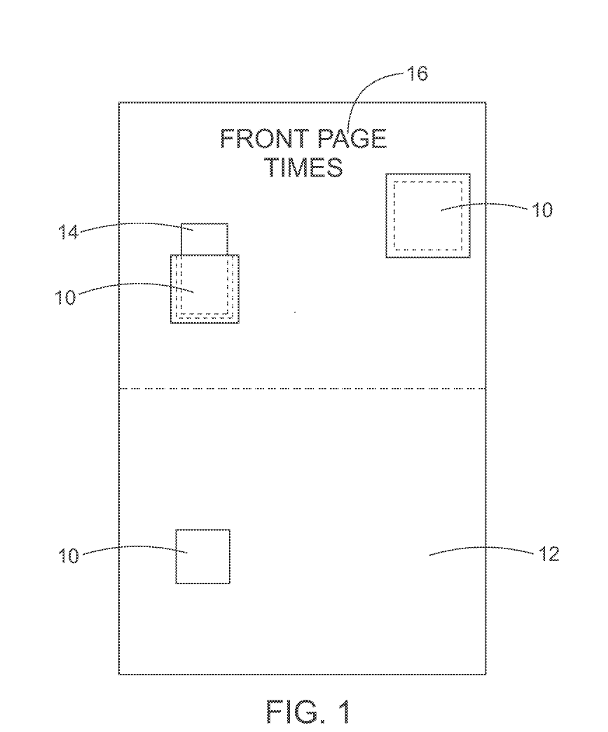

The examples described herein include an apparatus that can be used for advertising and a business method that can be used along with the apparatus for advertising. Examples of the apparatus are shown in FIGS. 1-7 and an example non-limiting business method is shown in FIG. 8. Other variations may be obvious to those of skill in the art and are encompassed herein.

Referring to FIG. 1, an example apparatus in the form of an advertising media 10 is shown positioned on a front page of a newspaper 12. A variety of locations are shown for the advertising media. For example, the advertising media could be positioned on an upper right corner of the newspaper near the masthead 16, or in lower locations, such as below the masthead or on the bottom half of the newspaper. The advertising media is designed such that it does not obscure the underlying text of the newspaper, either by being fully removable such that the newspaper is not substantially marred or leaving only a clear plastic layer so that a reader can read the material under the plastic layer.

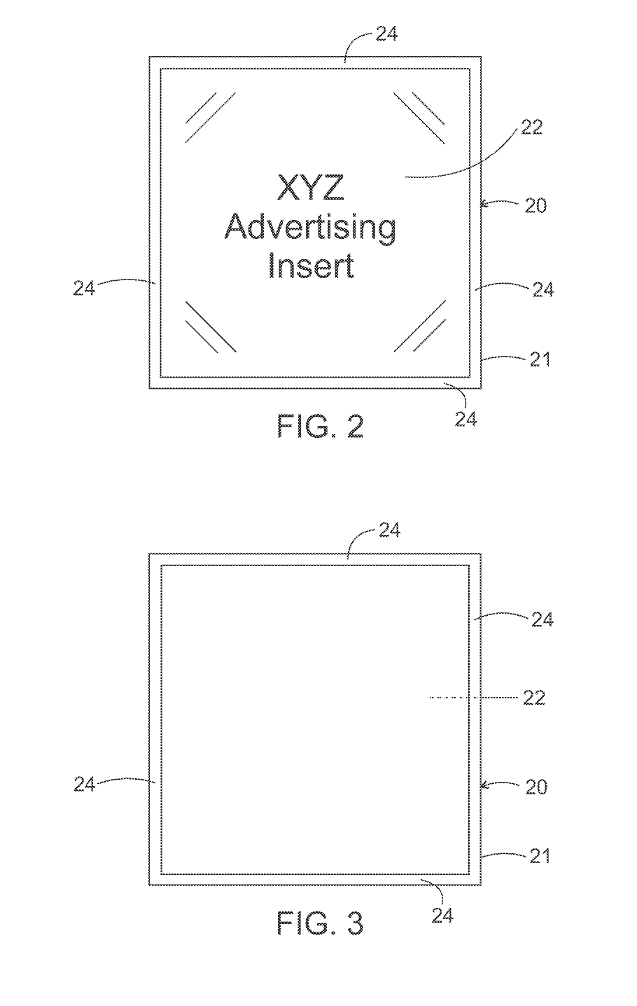

Referring to FIGS. 2 and 3, a first example advertising media 20 is shown in the form of a sleeve 21 or pocket for holding an insert 22. The insert 22 may be a larger insert or a full-size insert that is folded in size so as to fit inside the sleeve. For example, the insert could be an 8½×11 inch paper or variations thereof, or a booklet with multiple pages. The sleeve may be a clear plastic sleeve or may be a solid, opaque sleeve. Printed matter may be provided on the sleeve, if desired. The sleeve may be sealed at least three of the outer edges 24 via a glue line that extends around the exterior of the sleeve in order to capture the insert within the sleeve. The glue may or may not touch the insert. The glue may be an ultra-removable adhesive so that the entire sleeve is removable from the newspaper, and, in the case where the glue touches the insert, the insert is fully removable from the sleeve.

FIG. 2 shows a clear plastic sleeve where the text of the insert is visible through the clear plastic sleeve. The sleeve 21 is sealed around all four edges 24 with a glue line. The insert may be removed by tearing or cutting the plastic sleeve to release the insert, or by completely removing the sleeve to remove the insert. When the sleeve 21 is completely removed, the adhesive that is utilized is removable, such as an ultra-removable adhesive. When the sleeve 21 is torn or cut to remove the insert, the adhesive may either be removable or permanent since a reader will still be able to read the content underneath the remnants of the sleeve. A removable adhesive is desirable because it is less likely to result in tearing of the newspaper and results in fewer recycling issues.

FIG. 3 depicts a solid, opaque sleeve 21 that may or may not have printing disposed on the outside, such as “Surprise Inside” or “Please Open” or “Daily Coupons” and the like. Advertising material may also be printed on the exterior surface of the sleeve (not shown). The sleeve 21 may be removable from the newspaper by utilizing a removable adhesive, such as an ultra-removable adhesive. The sleeve has a glue line around the four edges 24 of the sleeve and the insert is positioned between the glue lines. The sleeve itself may be glued to the insert, if desired.

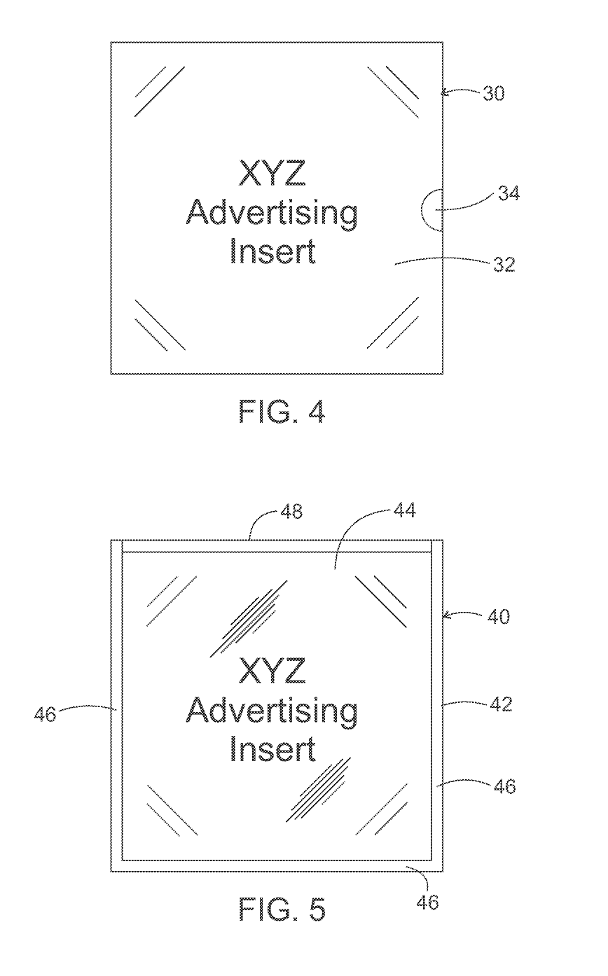

FIG. 4 depicts another example advertising media 30. In this example, an insert 32 is provided without a sleeve. The insert is folded and secured together in a known manner, such as using a sticker 34 or other closing apparatus to close the insert. A removable adhesive, such as an ultra-removable adhesive is applied to a rear surface of the insert and this adhesive serves to secure the insert to the newspaper. In another example, an insert is applied to a backing layer with an ultra-removable adhesive and the backing layer also includes an ultra-removable adhesive such that the insert can be removed from the backing layer and the backing layer can be removed from the media. The backing layer could be clear or opaque.

FIG. 5 depicts another example advertising media 40 where the sleeve 42 is only secured on three of the four sides and an insert 44 is positioned under the sleeve. In this example, the sleeve is shown as being transparent, but could be opaque, as described above in connection with FIG. 3. The insert is glued to the underlying surface using three glue lines that are positioned on three sides 46 of the sleeve. Since the sleeve is transparent, the insert is visible through the sleeve. Instead of having to remove the sleeve from the newspaper, the insert may be slid out of the sleeve via the top opening 48. Alternatively, the sleeve may be applied with a removable adhesive so that the entire sleeve can be removed from the newspaper without substantially marring the paper.

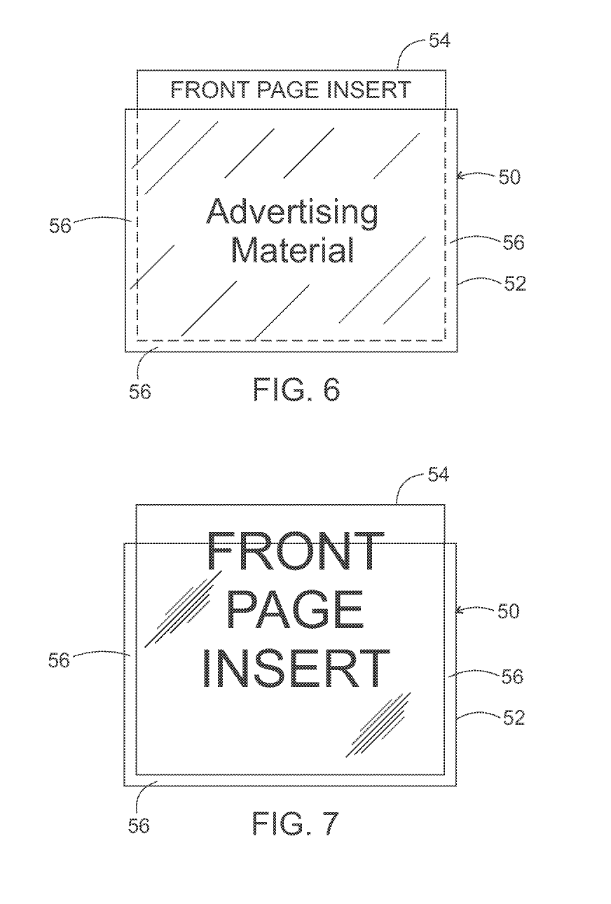

FIGS. 6 and 7 depict an example advertising media 50 where the sleeve 52 is shorter than the insert 54. The examples shown utilize a 3″×3½″ size for the advertising media, but have a sleeve that is truncated so that the insert sticks out of the top edges of the sleeve. The protruding insert makes the insert easier for a user to grab, without having to tear open the sleeve. This type of product may be positioned using currently existing placement equipment. The sleeve shown in FIG. 6 has an opaque surface. Glue lines are provided around three sides 56 of the sleeve in order to attach the sleeve to the newspaper. Advertising material or wording may be printed on the exterior surface of the sleeve. The insert is folded in order to fit within the sleeve so that the insert provides a larger overall size than the size of the sleeve. The sleeve is attached with a removable adhesive, such as an ultra-removable adhesive.

FIG. 7 is like the example in FIG. 6, but shows the sleeve 52 being made of a transparent material so that the insert 54 is visible through the sleeve. In this case, the sleeve may be applied with a removable adhesive or a permanent adhesive, as long as the user can read the material that is positioned beneath the sleeve.

While an insert is discussed in connection with the above examples, the advertising media could alternatively be an ultra-removable sticker, an ultra-removable booklet, or an insert that is positioned inside a clear or opaque sleeve, or any combinations thereof. The insert may be a light weight stock paper or material in order to allow the insert to be folded into a size that allows it to fit into the sleeve. For example, the stock may be 27 to 45 lb weight paper. A typical size for the sleeve is 3 inches by 3½ inches, which coincides with the size permitted in applicators that are utilized at most major newspapers. Other sizes may also be used. The advertising media could be hand or machine applied.

While the above examples are discussed in the context of inserts that are applied to a newspaper, the sleeve could be used to house samples, products, flyers, menus, and the like. The insert may be preprinted and inserted after the sleeve is applied. For example, the sleeve could be applied during the printing process and the insert could be inserted by hand. The sleeves or inserts may be applied using a dropper, which is a conventional machine used in the printing process. While the above examples are discussed in the context of a newspaper, any type of printed matter may derive a benefit from the examples discussed herein. The invention is not limited to the disclosed embodiments.

The sleeve may be made of a laminated polypropylene material. Laminated polypropylene gives the sleeve a nice appearance and sheen. The sleeve could be an opaque piece of paper material that hides the contents of the insert. This would provide the user with a secret surprise or mystery surprise inside the sleeve, which would encourage a curious user to open the sleeve. The sleeve, whether transparent or opaque, could include an electronic code that can be used with a computing device, such as with a computer on the internet. The computer code can be tied to more advertising and/or to a prize such that a consumer is encouraged to open the sleeve and enter the code to see whether or not they have won a prize. The consumer could be required to enter email and other personal information before being told whether or not they have won a prize, which allows the merchant to gather more names and email addresses for advertising purposes. The code could also be used for text messaging or other electronic forms of media in order to determine whether a reader has won a prize. The insert could include bar codes which can be read by smart phones in order to determine whether the user has won a prize. Any known type of electronic media presently used or used in the future could be utilized with the herein described advertising mechanism.

The sleeves may be in any desired size. Machine applied sleeves will typically have a size, such as a width, that allows stock to be applied with a machine on premises at a newspaper manufacturing facility. For non-standard sizes, they may be applied by hand either on the premises of the printing presses or by a carrier or delivery person. Non-standard sizes could also be applied with specialized machinery.

When an electronic code is used, such as in a system that provides front page rewards, the code could provide access to a reward, a surprise, games, or any other type of service. The user could be prompted to open the sleeve in order to see their savings. The user could be prompted to go to a specialized web page that is associated with the front page reward or could be directed to a specific manufacturer's or service provider's website. In either case, the consumer could be directed to enter email information in order to obtain the reward, which would allow for collection of email addresses or they could be added to a mailing list. The website could be used to collect buyer metrics, to allow users to redeem offers, to allow users to link to other websites and other offers and the like. The website could be used to sell advertising space to advertisers.

The above-described examples could also be used with direct mail, magazines, books, and other media. The examples could also be used on shipping boxes, envelopes, paper bags, grocery bags, or the like.

The method of advertising may include a message that is positioned on the front page and that serves as a reward or prize, with instructions to the user to open to find out what is inside. The front page insert could be a game or sweepstake that readers could play by using the internet or by mail, telephone, text, or other media. The front page insert could include a coupon offer that requires a consumer to enter an email address. The front page insert could direct a user to a website that could include such things as advertiser's sites, daily features, services advertising, and the like.

FIG. 8 depicts an example advertising method. The front page insert is first sold to an advertiser. In addition, advertising content on a web page may be sold to an advertiser. A front page insert is positioned on a front page of a newspaper with the advertiser's content. A reader opens the front page insert and receives a code or other instructions for entering the code or receiving a special offer. The insert may include coupons such that a special code is not required. The user may be given instructions on entering the code on the internet, via text, or via phone, or the like. The user may enter the code or other information into a website. The user may, in addition to or alternatively send a text message to be given further instructions. The user may, in addition to or alternatively to the above, place a call to be given further instructions. When the user enters the webpage, he may be instructed to enter a code to determine whether or not he has won a prize and would be given further instructions.

In all three scenarios, user data may be collected, including telephone number, address, email address, and the like. This data may be used as part of a data collection or may be sold. In addition, the user may be allowed to select a box that will permit the advertiser to send email or other correspondence to the user to provide additional advertising content. In each case, the user may be directed to other media. For example, the text and/or phone callers may be directed to a webpage, to additional advertising and offers, or to a link to an advertiser's website. Any number of advertising techniques may be utilized with the subject invention.

An example of an ultra-removable adhesive is discussed in U.S. patent application Ser. No. 13/004,411, filed on Jan. 11, 2011, the disclosure of which is incorporated herein by reference in its entirety.

A media process for advertising includes positioning an insert on a front page of a periodical, wherein the insert is removable from the periodical so that a purchaser can read any periodical content that is positioned under the insert and the insert includes instructions for the user to obtain additional advertising material. The periodical may be a high volume print media. The high volume print media may be a newspaper.

The positioning step may include producing a sleeve and positioning an insert inside the sleeve, wherein the sleeve is adhered to the periodical. The media process may include tearing open the sleeve to remove the insert from the sleeve. The insert, when removed from the sleeve, is a free-standing insert. The sleeve may be opaque and a backing material that is used to attach the sleeve to the front page may be ultra-removable so that removal of the sleeve does not substantially mar the periodical content.

A cover may be positioned over the insert, with the insert being a full size insert that is folded and the cover being a clear plastic material that has wings on either side, with the clear plastic having an adhesive adhered thereto that is ultra-removable. One of the sleeve or the insert includes a command that instructs the user to access electronic content on the internet, send a text message, or place a telephone call. The command may be an internet code to allow a user to obtain additional advertising utilizing the code or to determine whether the user has won a prize. The additional advertising may be computer media that includes coupons or special offers.

The method of advertising may included positioning media on the front page of a periodical, with the media including a periodic offer. The media may be removable from the front page of the periodical without substantially marring the front page of the periodical. The periodic offer may be a daily offer, a weekly offer, or a monthly offer.

The media process for advertising may include positioning an ultra-removable article onto a front page of a periodical, with the article including advertising material. The article may further include a code for accessing a web page on the internet and, upon entering the code, the user is at least one of instructed to enter contact information or told whether they have won a prize. The article may be a sleeve and the advertising material is one or more of a full-size advertising brochure with one or more pages or a coupon booklet.

An apparatus for advertising on a front page of a periodical may include a sleeve for holding an insert, an adhesive applied to a bottom surface of the sleeve, said adhesive for adhering to a front page of a periodical, and an insert positioned inside the sleeve. The insert and sleeve are together adhered to a front page of a periodical.

The apparatus may also include a code printed an exterior surface of one of the sleeve or the insert. The code may be an electronic code that can be used on an internet website to obtain additional advertising material. The insert may include a prize for the user. The prize may be an internet code that may allow the user to win a prize or coupons when the code is entered into a webpage. The insert may be a sample product and may also include an optional leaflet that accompanies the sample. An adhesive may be applied only around the edges of the sleeve and not onto the insert. The sleeve may have four sides and each of the sides may include a glue line along an edge thereof. The sleeve may have four sides and three of the four sides may include a glue line along an edge thereof.

The term “substantially,” if used herein, is a term of estimation. Content is “substantially marred” when a user cannot read the content. Content is not substantially marred when it is faded, or when some of the ink on the newspaper transfers with the adhesive that is coupled to the sleeve or sticker. While the “newspaper” shown in the figures does not appear to include text, it should be understood that this is only a representation. It is understood that a newspaper will be covered with text and other matter, even though not shown.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A media process for advertising comprising:
positioning an insert on a front page of a periodical;
wherein the insert is removable from the periodical so that a purchaser can read any periodical content that is positioned under the insert and the insert includes instructions for the user to obtain additional advertising material.

2. The media process of claim 1, wherein the positioning step includes producing a sleeve and positioning an insert inside the sleeve, wherein the sleeve is adhered to the periodical.

3. The media process of claim 1, wherein the periodical is a high volume print media or the periodical is a newspaper.

4. The media process of claim 2, wherein the insert, when removed from the sleeve, is a free-standing insert.

5. The media process of claim 2, wherein the sleeve is opaque and a backing material that is used to attach the sleeve to the front page is adhered with an ultra-removable adhesive so that removal of the sleeve does not substantially the periodical content, and further comprising tearing open the sleeve to remove the insert from the sleeve.

6. The media process of claim 1, further comprising a cover positioned over the insert, with the insert having a size that is greater than the size of the insert and that is folded, and the cover being a clear plastic material that has wings on either side, with the clear plastic having an adhesive adhered thereto that is ultra-removable.

7. The media process of claim 2, wherein one of the sleeve or the insert includes a command that instructs the user to access electronic content on the internet, send a text message, or place a telephone call.

8. The media process of claim 7, wherein the command is an internet code to allow a user to obtain additional advertising utilizing the code or to determine whether the user has won a prize.

9. The media process of claim 8, wherein the additional advertising is computer media that includes coupons or special offers.

10. A media process for advertising using a periodical comprising:
adhering an article onto a front page of a periodical using an adhesive;
wherein the article includes advertising material.

11. The media process of claim 10, wherein the adhesive is an ultra-removable adhesive that permits the article to be removed from the periodical without marring any content that is present on the periodical.

12. The media process of claim 10, wherein the advertising material includes a periodic offer.

13. The method of claim 12, wherein the periodic offer is one of a daily offer, a weekly offer, or a monthly offer.

14. The media process of claim 10, wherein the article further includes a code for accessing a web page on the internet and, upon entering the code, the user is at least one of instructed to enter contact information or told whether they have won a prize.

15. The media process of claim 10, wherein the article is a sleeve and the advertising material is one or more of an advertising brochure having a size that is greater than the size of the sleeve and has one or more pages or a coupon booklet having an overall size that is greater than the size of the sleeve when opened.

16. Apparatus for advertising on a front page of a periodical comprising:
a sleeve for holding an insert;
an adhesive applied to a bottom surface of the sleeve, said adhesive for adhering to a front page of a periodical; and
an insert positioned inside the sleeve, wherein the insert and sleeve are together adhered to a front page of a periodical.

17. The apparatus of claim 16, further comprising a code printed an exterior surface of one of the sleeve or the insert, said code being an electronic code that can be used on an internet website to obtain additional advertising material.

18. The apparatus of claim 16, wherein the insert includes a prize for the user, or the insert is a sample product and further comprises an optional leaflet that accompanies the sample product.

19. The apparatus of claim 18, wherein the insert includes a prize and the prize is an internet code that may allow the user to win a prize or coupons when the code is entered into a webpage.

20. The apparatus of claim 16, wherein the adhesive is applied only around the edges of the sleeve and not onto the insert, and the sleeve has four sides and at least three of the sides includes a glue line along the edge thereof.
